(19) United States
(12) Patent Application Publication
(10) Pub. No.: US 2007/0246158 A1
(43) Pub. Date: Oct. 25, 2007

(54) Wiring board, production process thereof and connection method using same

(75) Inventors: Hideo Yamazaki, Austin, TX (US); Yoshiyuki Ohkura, Tokyo (JP); Nathan P. Kreutter, Austin, TX (US); Shoji Takeuchi, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/408,373

(22) Filed: Apr. 21, 2006

(51) Int. Cl. B32B 3/00

(52) U.S. Cl. 156/306.6; 428/209

(57) ABSTRACT

The present invention provides a wiring board capable of realizing electrical connectivity even with connection leads having a fine pitch of 100 μm or less. The present invention relates to a wiring board with adhesive film comprising: a wiring board, in which the surface of a connection terminal portion on the end of a connection lead on the wiring board has a non-flat shape formed by a plating method; and, an adhesive film that covers the surface of the connection terminal portion and contains either a thermoplastic resin or a thermoplastic, thermosetting resin.

### FIELD

The present invention relates to a wiring board, a production process thereof and a connection method using the same.

### BACKGROUND

The connection terminal portions on the ends of connection leads arranged on a wiring board are connected to, for example, integrated circuits (IC), liquid crystal display panels (LCD), other wiring boards (such as printed boards) and connectors. Although several methods are employed when connecting to an IC or printed board, if the distance between wires (pitch) of the connection leads is 100 μm or less, there are many cases in which an anisotropic conductive adhesive film (ACF) is used. In addition, a connection portion which is needed to be removed is connected using a connector.

In the case of ACF connection, electrical continuity is realized by the connection leads pinching and capturing conductive particles dispersed in the adhesive from above and below. In addition, conductive particles that are not captured are pushed away into the gaps between the connection leads and the adhesive is solidified or cured with these conductive particles not making mutual contact. However, if the pitch of the connection leads is too narrow, the number of particles captured per wire decreases resulting in a decrease in connection reliability. In addition, mutual contact between particles that have been pushed away into the gaps between connection terminal causes an electrical short. Consequently, contrivances have been made such as coating the surfaces of the conductive particles with a resin and ensuring that the conductive portions of the conductive particles are exposed only when a large pressure is applied as when pinched by the connection leads (see, for example, Japanese Unexamined Patent Publication No. H07-197001). In addition, increasing fineness of the connection leads may also be accommodated by using multiple layers of adhesive.

In order to improve the electrical connection properties of the connection leads to an IC or wiring board, processing is known that consists of roughening the surfaces of the connection leads. In Japanese Unexamined Patent Publication No. S61-195568 for example, a film connector is disclosed in which a pattern having conductive projections is formed on a flexible substrate, and the entire pattern is covered with an adhesive composed of a thermoplastic resin or thermoplastic, thermosetting resin. Effects are described consisting of obtaining electrical continuity as a result of the projections pushing away the adhesive during hot pressing, and protection of the pattern as a result of covering the entire pattern with the adhesive. In the working examples, however, this pattern having conductive projections is obtained by printing a conductive paste, spraying a conductive powder, and removing the surplus powder followed by heat curing, and can only be applied to wiring composed of conductive paste, which makes it difficult to accommodate fine pitches.

Japanese Unexamined Patent Publication No. S62-184788 discloses a process for forming electrical continuity by providing non-flat shape on the surfaces of at least one group of conductors of two opposing groups of conductors and hot pressing with an insulating adhesive there between. However, the majority of the data indicated in the working examples relates to having a conductor pitch of 0.4 to 0.8 mm. Only sandpaper processing and embossing roll processing are indicated as methods for providing the non-flat surface, thus preventing this from being suitable for processing of conductors having a fine pitch.

On the other hand, although not relating to the establishment of connection in the case the distance between wires (pitch) of the connection terminal portion of a wiring board is small, Japanese Unexamined Patent Publication No. H6-270331 describes the carrying out of surface roughening processing by a plating method on the surface of an electrolytic copper foil in the production process of a copper-clad wiring board. This surface roughening processing is carried out to improve the adhesiveness between the copper foil and resin substrate that compose the printed wiring board, and does not constitute roughening the surface in order to establish an electrical connection to an integrated circuit (IC) or wiring board.

### SUMMARY

Therefore, an object of one aspect of the present invention is to provide a wiring board capable of realizing electrical connectivity even with a connection lead having a narrow pitch of 100 μm or less, and particularly 60 μm or less.

The present invention, in one aspect thereof, provides (1) a wiring board with adhesive film comprising:

a wiring board, in which the surface of a connection terminal portion on the end of a connection lead on the wiring board has non-flat shape formed by a plating method; and,

an adhesive film that covers the surface of the connection terminal portion and contains either a thermoplastic resin or a thermoplastic, thermosetting resin.

The present invention, in another aspect thereof, provides (2) a wiring board described in (1) above wherein, the non-flat shape has a ten-point mean roughness (Rz) of 0.8 μm or more as measured over the range of a reference length of 147 μm, and a mean spacing (Sm) of 3 μm or more.

The present invention, in still another aspect thereof provides (3) the wiring board described in (1) or (2) above wherein, the non-flat shape is formed by immersing the connection terminal portion of the wiring board in a copper sulfate plating bath having a sulfuric acid concentration of 50 g/l to 250 g/l for 0.5 to 120 minutes and plating at a current density of 1 to 50 A/dm².

The present invention, in still another aspect thereof, provides (4) a production process of a wiring board with adhesive film comprising:

obtaining a wiring board, in which a surface of a connection terminal portion is formed having a non-flat shape by metal plating the connection terminal portion on the end of a connection lead of the wiring board by a plating method; and,

applying an adhesive film to the connection terminal portion of the wiring board that contains a thermoplastic resin or a thermoplastic, thermosetting resin.

The present invention, in still another aspect thereof, provides (5) the production process of a wiring board with adhesive film described in (4) above wherein, the application of the adhesive film is carried out by hot pressing the adhesive film.

The present invention, in still another aspect thereof, provides (6) a production process of a wiring board comprising:

obtaining a wiring board in which a surface of a connection terminal portion is formed having a non-flat shape by metal plating the connection terminal portion on the end of a connection lead of the wiring board by a plating method;

arranging the connection terminal portion of the wiring board relative to a conductor serving as an electrical connection partner with an adhesive film containing a thermoplastic resin or a thermoplastic, thermosetting resin therebetween; and,

hot pressing the connection terminal portion of the wiring board and the conductor serving as an electrical connection partner at an adequate temperature and pressure to contact the connection terminal portion and the conductor serving as an electrical connection partner by pushing away the adhesive film.

### BRIEF DESCRIPTION OF THE DRAWINGS

FIG. 1 A digital image of a scanning electron micrograph (SEM) of the structure of the surface of wires on a wiring board prior to plating treatment.

FIG. 2 A digital image of a scanning electron micrograph (SEM) of the structure of the surface of wires on a wiring board following plating treatment.

### DISCLOSURE

According to the wiring board with adhesive film of the present invention, since the adhesive film is pushed away as a result of having a non-flat shape formed by plating the connection terminal portion of the wiring board, a satisfactory connection can be formed by the wiring board with another conductor without using an anisotropic conductive adhesive film (ACF) of the prior art. In addition, corrosion resistance is improved since the adhesive film protects the wiring of the wiring board.

The following provides an explanation of the present invention based on preferred embodiments thereof.

A wiring board used in at least one embodiment of the present invention imparts a non-flat shape to a wiring connection terminal portion by plating. There are no particular limitations on the wiring board used in this plating procedure, and examples of wiring boards that can be used include typical wiring boards in which wiring composed of copper (Cu) or copper alloy is formed on an insulating substrate such as a film of polyimide, polyester or polyamide and the like or glass epoxy. Furthermore, a copper wiring board can be produced according to ordinary methods by forming copper wiring by a known method such as by combining a semi-additive method or subtractive method with known photolithography, followed by forming a solder resist.

The non-flat shape formed on the surface of this wiring is obtained by electroplating or chemical plating. Non-flat surface is formed with a metal such as copper (Cu), nickel (Ni), gold (Au), palladium (Pd) or tin (Sn) on the wiring. Although, in general, the greater the height difference of the non-flat shape the better, if the height difference is attempted to be increased excessively, the uniformity of the non-flat shape tends to be lost. In addition, although the greater the density of the non-flat shape the better since a larger number of contact formation points is preferable during electrical connection, if the density is excessively large, it becomes difficult to ensure an adequate height difference for the non-flat shape. The non-flat shape preferably has a ten-point mean roughness (Rz) of 0.8 μm or more as measured over the range of a reference length of 147 μm, and a mean spacing (Sm) of 3 μm or more. Here, the ten-point average roughness (Rz) is determined according to the calculation formula defined in JIS B0601-1994. The mean spacing (Sm) is determined according to the calculation formula defined in ISD4287/1-1997. Rz is measured by selecting a reference length (l) from the roughness curve, and measuring the direction perpendicular to the mean line of this selected portion. The sum of the mean value of the absolute value of the height (Yp) up to and including the fifth peak from the highest peak, and the mean value of the absolute value of the depth (Yu) down to and including the fifth valley from the lowest valley, is determined, and that value is represented in micrometers (μm). Namely, Rz is expressed as Rz=(Yp1+Yp2+Yp3+Yp4+Yp5+Yv1+Yv2+Yv3+Yv4+Yv5/5 (wherein, Yp1 . . . Yp5 respectively indicate the height up to and including the fifth peak from the highest peak of the selected portion of the reference length (l), while Yv1 . . . Yv5 respectively indicate the depth down to and including the fifth valley from the lowest valley of the selected portion of the reference length (l)). On the other hand, Sm is the mean spacing between peaks. A peak must cross above the mean line and then back below it. Sm is measured by selecting an evaluation length (l′) from the roughness curve, and determining a width of each peak (Si) and calculating the mean value of the width. Namely, Sm is expressed as Sm=(S1+S2+S3+ . . . +Si+ . . . Sn)/n (wherein, Si is a spacing between adjacent peaks and n is the number of the spacings in the evaluation length (l′). The mean line is a linear line connecting points of mean height of the roughness curve.

Furthermore, in the present specification, the reference length (l) and the evaluation length (l′) are taken to be 147 μm, and Rz and Sm are measured using the Type VK-8500 Ultra-Deep Shape Measuring Microscope manufactured by Keyence Corp.

Although a gloss additive is normally added to the plating bath to smoothen the surface in the case of carrying out metal plating, in the present invention, metal plating treatment is carried out without adding such an agent so that the plated surface forms a non-flat shape. There are no particular limitations on the conditions of metal plating treatment provided the aforementioned non-flat shape is obtained. For example, in the case of electroplating with copper (Cu), a non-flat shape is formed by immersing the connection terminal portion of the wiring board in a copper sulfate plating bath having a sulfuric acid concentration of 50 g/l to 250 g/l for 0.5 to 120 minutes, and preferably for 3 to 40 minutes, and plating at a current density of 1 to 50 Angstrom/square decimeters (A/dm²). The reason for setting the limits of the current density as described above is that if the current density is less than 1 A/dm², plating treatment time becomes excessively long, while if the current density exceeds 50 A/dm², unevenness occurs locally in the deposited plating, thereby making control difficult for obtaining plating of uniform thickness. The immersion time is defined based on the relationship with the aforementioned current density to obtain the desired plating thickness (1 to 15 μm).

The thickness of the plating for providing a non-flat shape is normally 1 to 15 μm. If the plating is excessively thick, the connection terminal portion becomes excessively thick, the distance between conductors decreases and shorting occurs easily. In addition, connection reliability also tends to decrease due to the loss of non-flat shape uniformity. On the other hand, if the plating is excessively thin, it is not possible to form an adequate non-flat shape.

After forming the non-flat shape, finishing plating such as gold (Au), nickel (Ni), nickel/gold (Ni/Au) or tin (Sn) plating can be further carried out depending on applications. In the case of having selected a relatively soft metal for the finishing plating material, connection reliability increases as a result of the projecting or raised portions effectively deforming during connection. Finishing plating can be carried out using the same conditions as ordinary finishing plating. The thickness of a nickel layer is normally 0.5 to 1.0 μm, and the thickness of a gold layer is normally 0.1 to 0.5 μm. In general, the total thickness of the finishing plating layer is 0.6 to 1.5 μm. If the finishing plating layer is excessively thick, the non-flat shape may end up disappearing, while if it is excessively thin, its effect becomes inadequate.

In many embodiments, the wiring board of the present invention at least has an adhesive film in the connection terminal portion of the wiring board. The wiring board of the present invention may also have an adhesive film on the entire wiring board. As a result of having this adhesive film, corrosion resistance can be imparted and shorting between wires can be prevented. In order to ensure corrosion resistance, the adhesive film is preferably coated on the connection terminal portion of the wiring board or over the entire wiring board soon after being provided with the non-flat shape surface. The film can be formed by a method in which a diluted resin solution is sprayed, a method in which a film is first formed followed by lamination or hot pressing, or a screen printing method. In addition, the adhesive film contains a thermoplastic resin that promotes connection continuity by being pushed away by the projecting portions of the wiring when hot pressed with a conductor member serving as the connection partner. In addition, the adhesive film can also contain a material that has characteristics which promote connection continuity by being pushed away by the projecting portions of the wiring during hot pressing and cause curing together with completion of hot pressing, namely a thermoplastic, thermosetting resin. More specifically, a preferable adhesive film containing a thermoplastic, thermosetting resin is available under the trade designation SH311 from Sumitomo 3M Ltd., Japan.

As previously described, a wiring board with adhesive film of the present invention can be obtained by carrying out plating for forming a non-flat shape on the connection terminal portion of a wiring board which is produced by an ordinary method such as copper wiring formation followed by carrying out finishing plating (depending on the case), and finally forming an adhesive film thereon.

According to another of its aspects, the present invention provides a method for connecting a wiring board comprising: obtaining a wiring board in which a surface of a connection terminal portion is formed having a non-flat shape by metal plating the connection terminal portion on the end of a connection lead of the wiring board by a plating method; arranging the connection terminal portion of the wiring board relative to a conductor serving as an electrical connection partner with an adhesive film containing a thermoplastic resin or a thermoplastic, thermosetting resin therebetween; and, hot pressing the connection terminal portion of the wiring board and the conductor serving as an electrical connection partner at an adequate temperature and pressure to contact the connection terminal portion and the conductor serving as an electrical connection partner by pushing away the adhesive film. Hot pressing is carried out at a temperature that exceeds the softening point or melting point of the resin for several seconds to several minutes at several MPa. As a result, the adhesive film can be pushed back and the connection terminal portion of the wiring board can be contacted with the conductor serving as the electrical connection partner. In this connection method, although the adhesive film may be provided separately from the wiring board or may be provided in the form of a wiring board with adhesive film, it is preferably provided in the form of a wiring board with adhesive film.

A connection terminal of a liquid crystal display panel, IC or printed circuit board and so forth is then connected to the connection terminal with a non-flat shape of the wiring board with adhesive film provided in the manner described above with a hot pressing machine. At that time, the projecting or raised portions on the wiring push away the adhesive film to form a contact point with the terminal on the opposing side, and the connection is established as a result of the adhesive film solidified when cooled. In addition, in the case the adhesive film contains a thermosetting component such as a thermosetting resin, a more stable electrical connection is established by curing the adhesive film with heat.

In addition, if the adhesive film is excessively thin or the gap between wires is excessively wide, there are cases in which the gaps between the wires may not be able to be completely filled in during hot pressing by only an adhesive film that covers the wiring board. In such cases, the connection terminal portion of the wiring board is hot pressed with the opposing connection terminal by forming a film of the same material as the adhesive film.

Furthermore, the gap between wires becomes narrower than in the original state as a result of forming a non-flat shape. As a result, the adhesive film may be unable to suitably flow during hot pressing, and an excessive pressure is required that imparts damage to the members in order to achieve satisfactory connection continuity. In order to avoid this, it is necessary to form the wires somewhat narrower or suitably select the thickness of the adhesive film in anticipation of the thickness resulting from plating for a non-flat shape formation.

The thickness of the adhesive film, although not limited thereto, is normally 10 to 50 μm. If the adhesive film has this thickness, the amount of adhesive for filling the gaps of the wires when connecting the wires is neither excessive nor insufficient.

### EXAMPLES

The following provides a further explanation of the present invention based on examples thereof. The examples are intended to exemplify the present invention, and the present invention is not limited thereby.

Conditions of Copper Sulfate Plating Bath

A solution consisting of 120 g/L of copper sulfate pentahydrate, 180 g/L of sulfuric acid and 45 mg/L of chlorine was used as the plating bath (solution of the present invention) for forming the non-flat shape in the present invention. On the other hand, a liquid containing 5 mL/L of a gloss additive available under the trade designation Top Lucina SF from Okuno Chemical Industries Japan was used as a control for the aforementioned solution of the present invention. Plating treatment was carried out for a target plating thickness of 8 μm at various current densities and treatment times.

TABLE 1
Target thickness: 8 [μm]

| | | | Plating | Plating | | |
|---|---|---|---|---|---|---|
| | Treatment time | | current | uni- | Rz | Sm |
| | Minutes | Seconds | waveform | formity | [μm] | [μm] |
| Current density | | | | | | |
| of solution | | | | | | |
| of present | | | | | | |
| invention [A/dm²] | | | | | | |
| 0.5 | 72 | 24 | DC | OK | 1.45 | 4.81 |
| 1.0 | 36 | 12 | DC | OK | 1.44 | 4.75 |
| 2.5 | 14 | 29 | DC | OK | 1.41 | 4.55 |
| 5.0 | 7 | 14 | DC | OK | 0.99 | 4.68 |
| 10.0 | 3 | 37 | DC | OK | 1.04 | 4.15 |
| 25.0 | 1 | 27 | DC | OK | 1.26 | 4.28 |
| 40.0 | 0 | 54 | DC | OK | 1.71 | 4.61 |
| 100.0 | 0 | 22 | DC | NG | — | — |
| Current density | | | | | | |
| of control | | | | | | |
| (Top Lucina | | | | | | |
| SF) [A/dm²] | | | | | | |
| 0.5 | 72 | 24 | DC | OK | 0.68 | 2.78 |
| 1.0 | 36 | 12 | DC | OK | 0.66 | 2.76 |
| 2.5 | 14 | 29 | DC | OK | 0.64 | 2.71 |
| 5.0 | 7 | 14 | DC | OK | 0.56 | 2.63 |
| 10.0 | 3 | 37 | DC | OK | 0.59 | 2.65 |
| 25.0 | 1 | 27 | DC | OK | 0.61 | 2.67 |
| 40.0 | 0 | 54 | DC | OK | 0.78 | 2.81 |
| 100.0 | 0 | 22 | DC | NG | — | — |

As is clear from Table 1, use of the solution of the present invention allowed the obtaining of a satisfactory and uniform non-flat shape having an Rz of 0.8 μm or more and Sm of 3 μm or more. On the other hand, a smooth surface was obtained with the control liquid (Top Lucina SF). Furthermore, Rz and Sm were measured using a microscope available under the trade designation Type VK-8500 Ultra-Deep Shape Measuring Microscope from Keyence Corp., Japan, based on the reference length and the evaluation length of 147 μm.

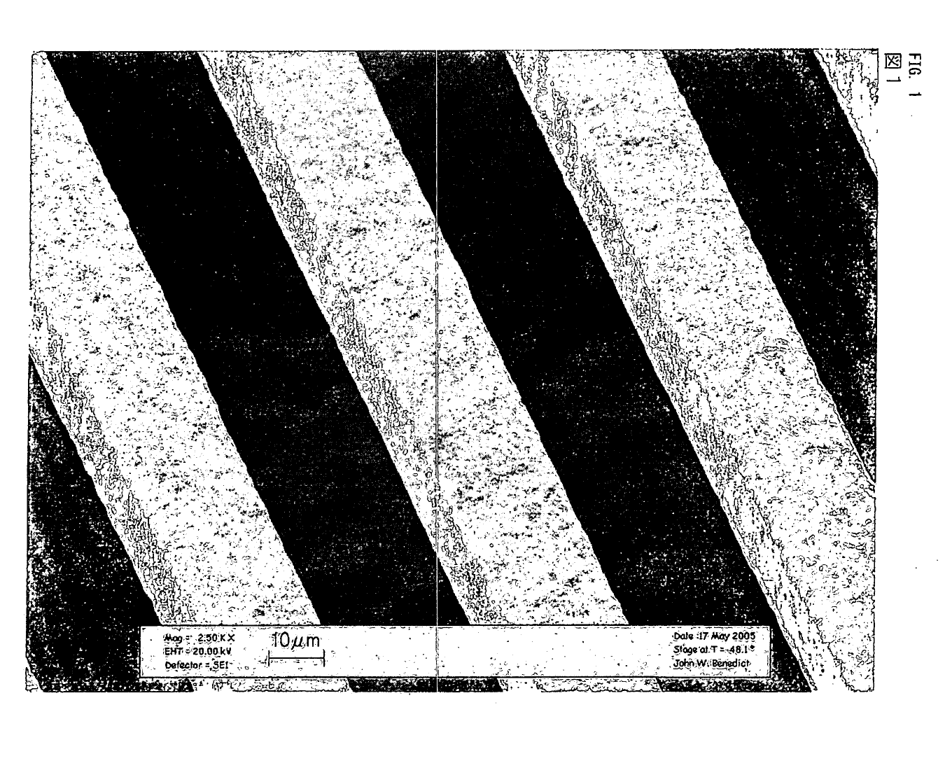

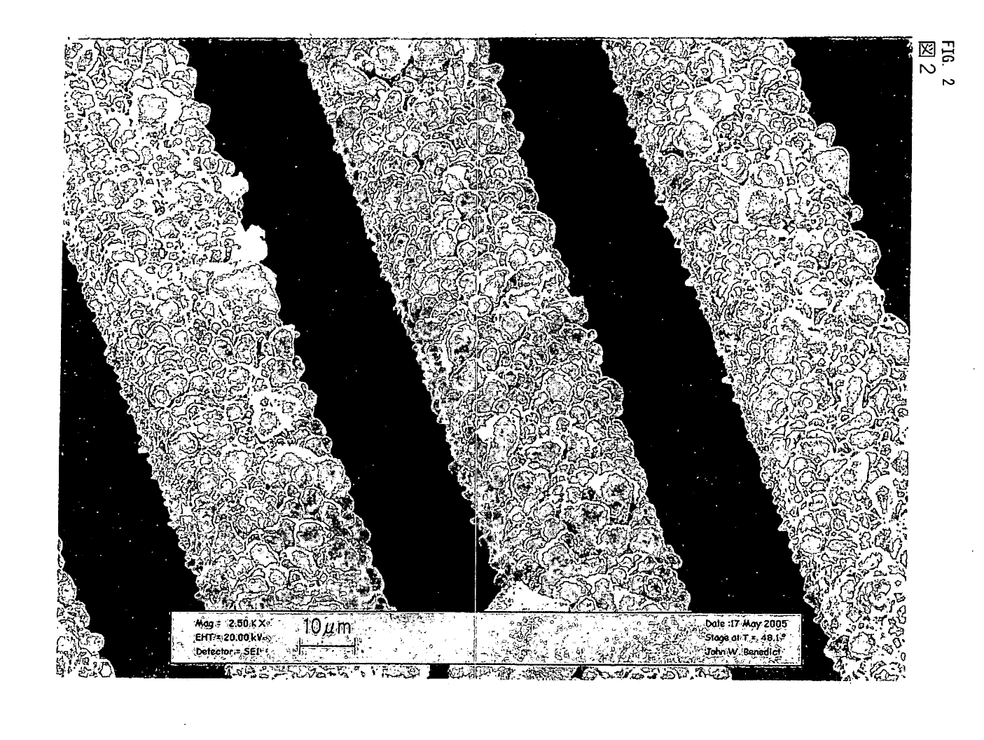

FIG. 1 is a scanning electron micrograph (SEM) of the structure of the surface of wires on a wiring board prior to plating treatment. In addition, FIG. 2 is a scanning electron micrograph (SEM) of the structure of the surface of wires following plating treatment for 54 seconds at a current density of 40 A/dm² using the solution of the present invention.

### Example 1

A flexible printed circuit (FPC) board was prepared on which copper wires having a pitch of 55 μm were formed, and the connection terminal portion on the wiring was subjected to plating treatment for 54 seconds at a current density of 40 A/dm² using the above-mentioned solution of the present invention to form a non-flat shape.

Finishing plating consisting of nickel (Ni) and gold (Au) at 0.5 μm and 0.3 μm, respectively, was carried out on the copper leads having a non-flat shape to produce a wiring board (FPC) having a non-flat shape in the connection terminal portion. On the other hand, a glass plate having an indium tin oxide (ITO) film formed on the surface thereof was prepared for the connection target. An adhesive film available under the trade designation SH311 from Sumitomo 3M, Ltd., Japan, (20 μm) was arranged between the wiring board having a non-flat shape in the connection terminal portion and the glass plate and connected. The connection conditions were as indicated below. After connecting, the connection resistance between the ITO and leads was measured and the connection was confirmed to be satisfactory.
FPC:
Base material: Polyimide film (available under the trade name KAPTON E from Dupont, thickness: 25 μm)
Copper leads: Wire width (L)/wire spacing (S)=40/15 μm, wire thickness: 18 μm
Connection Conditions:
Temperature: 180° C.
Time: 10 seconds
Pressure: 8 MPa

### Example 2

A wiring board in which copper wires were formed at a pitch of 55 μm was prepared followed by plating treatment for 54 seconds at a current density of 40 A/dm² using the above-mentioned solution of the present invention to form a non-flat shape.

Finishing plating consisting of nickel (Ni) and gold (Au) at 0.5 μm and 0.3 μm, respectively, was carried out on the copper wiring having a non-flat shape to produce a wiring board (FPC) having a non-flat shape in the connection terminal portion. Subsequently, the connection terminal portion was coated with a diluted solution of SH311 adhesive in tetrahydrofuran (THF) using an air brush method followed by treating for 10 minutes at 100° C. to form a film having a thickness of 4 μm.

On the other hand, a glass plate having an indium tin oxide (ITO) film formed on the surface thereof was prepared for the connection target. The wiring board treated in the manner described above was connected to this glass plate by hot pressing. The connection conditions were as indicated below. After connecting, the connection resistance between the ITO and board wiring was measured and the connection was confirmed to be satisfactory.
FPC:
Base material: Polyimide film (KAPTON E, Dupont, thickness: 25 μm)
Copper leads: Wire width (L)/wire spacing (S)=40/15 μm, wire thickness: 18 μm
Connection Conditions:
Temperature: 180° C.
Time: 10 seconds
Pressure: 8 MPa

### Example 3

A wiring board in which copper wires were formed at a pitch of 55 μm was prepared followed by plating treatment for 54 seconds at a current density of 40 A/dm² using the above-mentioned solution of the present invention to form a non-flat shape.

Finishing plating consisting of nickel (Ni) and gold (Au) at 0.5 μm and 0.3 μm, respectively, was carried out on the copper wiring having a non-flat shape to produce a wiring board (FPC) having a non-flat shape in the connection terminal portion. Subsequently, the connection terminal portion was coated with a diluted solution of SH311 adhesive in tetrahydrofuran (THF) using an air brush method followed by treating for 10 minutes at 100° C. to form a film having a thickness of 4 μm.

On the other hand, a glass plate having an indium tin oxide (ITO) film formed on the surface thereof was prepared for the connection target. In addition, a film was formed having a thickness of 18 to 20 μm by coating with a diluted solution of adhesive SH311 in tetrahydrofuran (THF) for 10 minutes at 100° C. The wiring board treated in the manner described above was connected to this glass plate through this adhesive film. The connection conditions were as indicated below. After connecting, the connection resistance between the ITO and board wiring was measured and the connection was confirmed to be satisfactory.
FPC:
Base material: Polyimide film (KAPTON E, Dupont, thickness: 25 μm)
Copper leads: Wire width (L)/wire spacing (S)=40/15 μm, wire thickness: 18 μm
Connection Conditions:
Temperature: 180° C.
Time: 10 seconds
Pressure: 8 MPa

1. A wiring board with adhesive film comprising:
a wiring board, in which the surface of a connection terminal portion on the end of a connection lead on the wiring board has a non-flat shape formed by a plating method; and,
an adhesive film that covers the surface of the connection terminal portion and contains either a thermoplastic resin or a thermoplastic, thermosetting resin.

2. The wiring board according to claim 1 wherein, the non-flat shape has a ten-point mean roughness (Rz) of 0.8 μm or more as measured over the range of a reference length of 147 μm, and a mean spacing (Sm) of 3 μm or more.

3. The wiring board according to claim 1 wherein, the non-flat shape is formed by immersing the connection terminal portion of the wiring board in a copper sulfate plating bath having a sulfuric acid concentration of 50 g/l to 250 g/l for 0.5 to 120 minutes and plating at a current density of 1 to 50 A/dm².

4. A production process of a wiring board with adhesive film comprising:
obtaining a wiring board, in which a surface of a connection terminal portion is formed having a non-flat shape by metal plating the connection terminal portion on the end of a connection lead of the wiring board by a plating method; and,
applying an adhesive film to the connection terminal portion of the wiring board that contains a thermoplastic resin or a thermoplastic, thermosetting resin.

5. The production process of a wiring board with adhesive film according to claim 4 wherein, the application of the adhesive film is carried out by hot pressing the adhesive film.

6. A method for connecting a wiring board comprising:
obtaining a wiring board in which a surface of a connection terminal portion is formed having an irregular shape by metal plating the connection terminal portion on the end of a connection lead of the wiring board by a plating method;
arranging the connection terminal portion of the wiring board relative to a conductor serving as an electrical connection partner with an adhesive film containing a thermoplastic resin or a thermoplastic, thermosetting resin therebetween; and,
hot pressing the connection terminal portion of the wiring board and the conductor serving as an electrical connection partner at an adequate temperature and pressure to contact the connection terminal portion and the conductor serving as an electrical connection partner by pushing away the adhesive film.
